(19) United States
(12) Patent Application Publication
(10) Pub. No.: US 2006/0162741 A1
(43) Pub. Date: Jul. 27, 2006

(54) Method and apparatus for cleaning and surface conditioning objects with plasma

(75) Inventor: Peter Frank Kurunczi, Houston, TX (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Cerionx, Inc.

(21) Appl. No.: 11/043,787

(22) Filed: Jan. 26, 2005

(51) Int. Cl. B08B 6/00; C23F 1/00

(52) U.S. Cl. 134/1.1; 156/345.43

(57) ABSTRACT

A method and apparatus for cleaning and surface conditioning objects using plasma is disclosed. One embodiment of the method discloses providing a plurality of elongated dielectric barrier plates arranged adjacent each other, the plates having inner electrodes connected therein, introducing the objects proximate the plates, and producing a dielectric barrier discharge to form plasma between the objects and the plates for cleaning at least a portion of the objects. One embodiment of the apparatus for cleaning objects using plasma discloses a plurality of elongated dielectric barrier plates arranged adjacent each other, and a plurality of inner electrodes, each contained within, and extending substantially along the length of, respective ones of the elongated dielectric barrier plates.

### CROSS-REFERENCE TO RELATED APPLICATIONS

This application is related to co-pending patent application, entitled “Atmospheric Pressure Non-Thermal Plasma Device To Clean and Sterilize The Surfaces Of Probes, Cannulas, Pin Tools, Pipettes And Spray Heads”, assigned Ser. No. 10/858,272 and filed Jun. 1, 2004; and co-pending patent application, entitled “Method and Apparatus for Cleaning and Surface Conditioning Objects Using Non-equilibrium Atmospheric Pressure Plasma, filed Jan. 21, 2005, both disclosures of which are commonly assigned with the present invention and are incorporated herein by reference.

### BACKGROUND OF THE INVENTION

1. Field of the Invention

Embodiments of the present invention generally relate to a method and apparatus for cleaning and surface conditioning objects, such as fluid handling devices, and in particular to a method and apparatus for cleaning and surface conditioning portions of fluid handling devices with non-equilibrium atmospheric pressure plasma.

2. Description of the Related Art

In certain clinical, industrial and life science testing laboratories, extremely small quantities of fluids, for example, volumes between a drop (about 25 micro-liters) and a few nano-liters may need to be analyzed. Several known methods are employed to transfer these small amounts of liquid compounds from a source to a testing device. Generally, liquid is aspirated from a fluid holding device to a fluid handling device. The fluid handling device may include, but is not limited to, a probe, cannula, disposable pipette, pin tool or other similar component or plurality of such components (hereinafter collectively referred to as “probes”). The fluid handling device and its probes may move, manually, automatically or robotically, dispensing the aspirated liquid into another fluid holding device for testing purposes.

Commonly, the probes, unless disposable, are reused from one test to the next. As a result, at least the tips and perhaps additional portions of the probes must be cleaned between each test. Conventionally, the probes undergo a wet “tip wash” process. That is, they are cleaned in between uses with a liquid solvent, such as Dimethyl Sulfoxide (DMSO) or simply water.

These methods and apparatus for cleaning and conditioning fluid handling devices have certain disadvantages. For example, the wet “tip wash” process takes a relatively long amount of time and can be ineffective in cleaning the probe tips to suitable levels of cleanliness. Furthermore, disposing the used solvents from the wet process presents environmental and cost issues. Thus, there is a need for improved methods and apparatus for cleaning and surface conditioning fluid handling devices.

### SUMMARY OF THE INVENTION

The present invention generally relates to an apparatus and method for cleaning objects using plasma. These objects include, but are not limited to, probes of a fluid handling device, and the like. More specifically, an embodiment of the apparatus comprises a plurality of elongated dielectric barrier plates, arranged adjacent each other and spaced apart to define predetermined gaps therebetween; and a plurality of inner electrodes, each contained within, and extending substantially along the length of, respective ones of the elongated dielectric barrier plates. The electrodes can be electrically connected to a voltage source. Probes can be introduced proximate the elongated dielectric barrier plates. When power is supplied to the inner electrodes and the probes are introduced proximate the elongated dielectric barrier plates, a dielectric barrier discharge is produced between at least one probe and at least one of the elongated dielectric barrier plates. The discharge forms plasma that cleans at least a portion of each probe.

In another embodiment of the present invention, there is provided a method for cleaning a plurality of non-conductive objects, comprising: providing a plurality of elongated dielectric barrier plates, each having inner electrodes arranged therein, the plates spaced apart to define predetermined gaps therebetween; providing a plurality of ground electrodes adjacent the plates; introducing non-conductive objects proximate the elongated dielectric barrier plates and the ground electrodes; and generating a dielectric barrier discharge to form plasma between the elongated dielectric barrier plates and respective ground electrodes for cleaning at least a portion of each of the non-conductive objects.

### BRIEF DESCRIPTION OF THE DRAWINGS

So the manner in which the above recited features of the present invention can be understood in detail, a more particular description of embodiments of the present invention, briefly summarized above, may be had by reference to embodiments, some of which are illustrated in the appended drawings. It is to be noted; however, the appended drawings illustrate only typical embodiments of the present invention and are therefore not to be considered limiting of its scope, for the present invention may admit to other equally effective embodiments.

FIG. 1A is a perspective view depicting a plurality of conductive probes introduced to a plurality of elongated dielectric barrier plates, having inner electrodes coupled to an AC voltage supply, in accordance with an embodiment of the present invention;

FIG. 1B is a partial, cross sectional schematic view of a pair of the elongated dielectric barrier plates of FIG. 1A depicting a conductive probe introduced between the plates;

FIG. 2 is a cross sectional schematic view depicting a non-conductive probe being introduced to a pair of elongated dielectric barrier plates having inner electrodes, and a ground electrode in accordance with an embodiment of the present invention;

FIG. 3 is a cross sectional schematic view depicting non-conductive probes being introduced to a pair of plates, with a ground electrode in accordance with another embodiment of the present invention;

FIG. 4A is a partial perspective view depicting a plurality of non-conductive probes introduced to a plurality of elongated dielectric barrier plates having inner electrodes coupled to a power supply, and outer ground electrodes arranged on the outer surfaces of the plates in accordance with an embodiment of the present invention;

FIG. 4B is partial, top plan view of a pair of the elongated dielectric barrier plates of FIG. 4A depicting conductive probes introduced to the pair of plates;

FIG. 5A is a partial perspective view depicting a plurality of non-conductive probes introduced to a plurality of elongated dielectric barrier plates having inner electrodes coupled to an AC voltage supply, and outer ground electrodes arranged on the outer surfaces of the plates in accordance with an embodiment of the present invention;

FIG. 5B is partial, top plan view of a pair of the elongated dielectric barrier plates of FIG. 5A depicting non-conductive probes introduced to the pair of plates;

FIG. 6 is a top plan view of a matrix or array of any one of the preceding devices showing the plurality of elongated dielectric barrier plates arranged in a microtiter plate format; and

FIG. 7 represents a graph of the relative concentrations of different chemical and particle species of plasma in time after the initiation of a single microdischarge that forms atmospheric pressure plasma in air.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments of the present invention as defined by the appended claims.

The headings used herein are for organizational purposes only and are not meant to be used to limit the scope of the description or the claims. As used throughout this application, the word “can” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

The term “plasma” is used to describe a quasi-neutral gas of charged and neutral species characterized by a collective behavior governed by coulomb interactions. Plasma is typically obtained when sufficient energy, higher than the ionization energy of the neutral species, is added to the gas causing ionization and the production of ions and electrons. The energy can be in the form of an externally applied electromagnetic field, electrostatic field, or heat. The plasma becomes an electrically conducting medium in which there are roughly equal numbers of positively and negatively charged particles, produced when the atoms/molecules in a gas become ionized.

A plasma discharge is produced when an electric field of sufficient intensity is applied to a volume of gas. Free electrons are then subsequently accelerated to sufficient energies to produce electron-ion pairs through inelastic collisions. As the density of electrons increase, further inelastic electron atom/molecule collisions will result in the production of further charge carriers and a variety of other species. The species may include excited and metastable states of atoms and molecules, photons, free radicals, molecular fragments, and monomers.

The term “metastable” describes a type of atom/molecule excited to an upper electronic quantum level in which quantum mechanical selection rules forbid a spontaneous transition to a lower level. As a result, such species have long excited lifetimes. For example, whereas excited states with quantum mechanically allowed transitions typically have lifetimes on the order of 10⁻⁹ to 10⁻⁸ seconds before relaxing and emitting a photon, metastable states can exist for about 10⁻⁶ to 10¹ seconds. The long metastable lifetimes allow for a higher probability of the excited species to transfer their energies directly through a collision with another compound and result in ionization and/or dissociative processes.

The plasma species are chemically active and/or can physically modify the surface of materials and may therefore serve to form new chemical compounds and/or modify existing compounds. For example, the chemically active plasma species can modify existing compounds through ionization, dissociation, oxidation, reduction, attachment, and recombination.

A non-thermal, or non-equilibrium, plasma is one in which the temperature of the plasma electrons is higher than the temperature of the ionic and neutral species. Within atmospheric pressure non-thermal plasma, there is typically an abundance of the aforementioned energetic and reactive particles (i.e., species), such as ions, excited and/or metastable atoms and molecules, and free radicals. For example, within an air plasma, there are excited, metastable, and ionic species of N₂, N, O₂, O, free radicals such as OH, HO₂, NO, O, and O₃, and ultraviolet photons ranging in wavelengths from 200 to 400 nanometers resulting from N₂, NO, and OH emissions. In addition to the energetic (fast) plasma electrons, embodiments of the present invention harness and use these “other” particles to clean and surface condition portions of liquid handling devices such as probes, and the like.

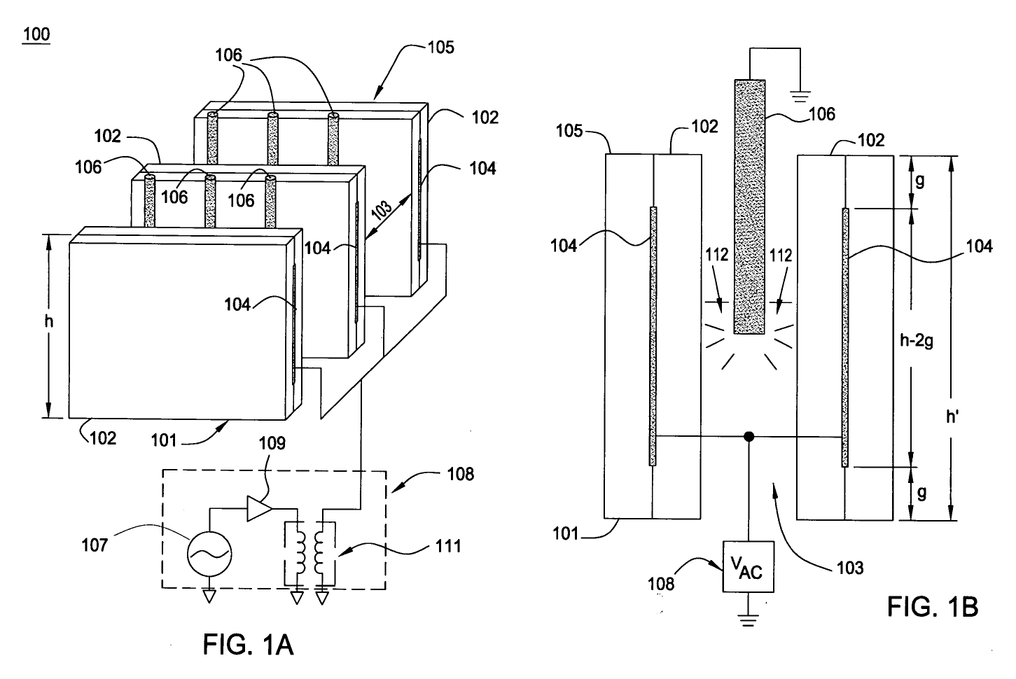

Referring to FIG. 1A, a perspective view of a portion of a non-thermal atmospheric pressure plasma cleaning device 100 in accordance with an embodiment of the present invention is disclosed. The device 100 includes a plurality of elongated dielectric barrier plates 102 arranged in a matrix or array and extending along a given plane. The elongated dielectric barrier plates 102 have a height “h” defined between a top 105 and a bottom 101. The plates 102 are substantially regularly spaced apart from each other, forming a predetermined gap 103 between adjacent plates 102. Each elongated dielectric barrier plate 102 includes an inner electrode 104 extending within, and substantially along the length of, respective elongated dielectric barrier plates 102. A plurality of objects, for example, conductive probes 106, are introduced between the plates 102 in the predetermined gaps 103.

In one embodiment, the probes 106 are part of a fluid handling device (not shown). As such, the probes 106 are attached to, and extend from, a fluid handling device, which may be part of a microtiter plate test bed set up. In another embodiment, the probes 102 may be any form of a conductive object or element that would benefit from plasma cleaning and surface conditioning. When referring to the use of “plasma” as a means for cleaning, it is to be understood that this may include the initial atmospheric pressure plasma formed from a dielectric barrier microdischarge and created between the elongated dielectric barrier plates and the conductive objects, as well as “other” particles or species described herein that remain relatively long after the initial plasma has dissipated.

The elongated dielectric barrier plates 102 can be made of any type of material capable of providing an area or surface for a dielectric barrier discharge of atmospheric pressure plasma (described below). Dielectric barrier material that can be used in this and other embodiments of the present invention includes, but is not limited to, ceramic, glass, plastic, polymer epoxy, or a composite of one or more such materials, such as fiberglass or a ceramic filled resin (available from Cotronics Corp., Wetherill Park, Australia) and the like.

In one embodiment, a ceramic dielectric barrier is alumina or aluminum nitride. In another embodiment, a ceramic dielectric barrier is a machinable glass ceramic (available from Corning Incorporated, Corning, N.Y.). In yet another embodiment of the present invention, a glass dielectric barrier is a borosilicate glass (also available from Corning Incorporated, Corning, N.Y.). In still another embodiment, a glass dielectric barrier is quartz (available from GE Quartz, Inc., Willoughby, Ohio). In an embodiment of the present invention, a plastic dielectric barrier is polymethyl methacrylate (PLEXIGLASS and LUCITE, available from Dupont, Inc., Wilmington, Del.). In yet another embodiment of the present invention, a plastic dielectric barrier is polycarbonate (also available from Dupont, Inc., Wilmington, Del.). In yet another embodiment, a plastic dielectric barrier is a fluoropolymer (available from Dupont, Inc., Wilmington, Del.). In another embodiment, a plastic dielectric barrier is a polyimide film (KAPTON, available from Dupont, Inc., Wilmington, Del.). Dielectric barrier materials useful in the present invention typically have dielectric constants ranging between 2 and 30. For example, in one embodiment that uses a polyimide film plastic such as KAPTON, at 50% relative humidity, with a dielectric strength of 7700 Volts/mil, the film would have a dielectric constant of about 3.5.

The inner electrodes 104 may comprise any conductive material, including metals, alloys and conductive compounds. In one embodiment, a metal may be used. Metals useful in this embodiment of the present invention include, but are not limited to, copper, silver, aluminum, and combinations thereof. In another embodiment of the present invention, an alloy of metals may be used as the inner electrode 104. Alloys useful in this embodiment of the present invention include, but are not limited to, stainless steel, brass, bronze and the like. In another embodiment of the present invention, a conductive compound may be used. Conductive compounds useful in the present invention include, but are not limited to, indium-tin-oxide, and the like.

The inner electrodes 104 of embodiments of the present invention may be formed using any method known in the art. In one embodiment of the present invention, the inner electrodes 104 may be formed using a foil. In another embodiment of the present invention, the inner electrodes 104 may be formed using a wire. In yet another embodiment of the present invention, the inner electrodes 104 may be formed using a solid piece of conductive material. In another embodiment of the present invention, the inner electrodes 104 may be deposited as an integral layer directly onto the inner core of the elongated dielectric barrier plates 102. In one such embodiment, an inner electrode 104 may be formed using a conductive paint, which is applied and adhered to the inner core of the elongated dielectric barrier plates 102.

The inner electrodes 104 are electrically connected to an AC voltage source 108. Alternatively, the inner electrodes 104 can be connected to a D.C. source. The conductive probes 106 are electrically grounded with respect to the AC voltage source 108. The AC voltage source 108 in this embodiment includes an AC source 107, a power amplifier 109 and a transformer 111, to supply voltage to the inner electrodes 104.

In one embodiment of the present invention, the conductive probes 106 extend from a fluid handling device proximate the elongated dielectric barrier plates 102. The probe 106, as shown, may also be introduced into the gap 103. Use of the term “probe” includes, but not limited to, probes, cannulas, pin tools, pipettes and spray heads or any portion of a fluid handling device that is capable of carrying fluid. These probe portions are generally hollow in order to retain the fluid under test. The probes may alternatively be solid and include a surface area capable of retaining fluid. All of these different types of fluid handling portions of a fluid handling device are collectively referred to in this application as “probes.” In an embodiment, the probe is conductive and is made of conductive material similar to that material described above in connection with the inner electrode 104.

FIG. 1B depicts a cross sectional schematic view of a pair of the elongated dielectric barrier plates 102 from the device 100 of FIG. 1A. Likewise, inner electrodes 104 are disposed within, and extend substantially along, the length of the pair of plates 102. In this embodiment, the inner electrodes 104 have a height “h” that is less than the height “h” of the elongated dielectric barrier plates 102. As depicted in FIG. 1B, the height h′ of each inner electrode is h-2g, where “g” is the distance from each end of the inner electrode to the top 105 and bottom 101 portions of each elongated dielectric barrier plate 102. In this embodiment, the distance is substantially the same amount “g” for each side. As such, the inner electrodes 104 are substantially equidistant from the top 105 and bottom 101 of the elongated dielectric barrier plates 102. One advantage of this arrangement of each inner electrode 104 within each plate 102 is to reduce or eliminate arcing between the inner electrodes 104 and the conductive probes 106, in operation when the probes 106 are introduced to the plates 102.

When a conductive probe 106 is introduced to the elongated dielectric barrier plates 102 within a predetermined gap 103, and power from the AC voltage source 108 is supplied to the inner electrodes 104, microdischarges or dielectric barrier discharge 112 is generated between the probes 106 and the elongated dielectric barrier plates 102 at least at or near the tip of the probes 106.

In the embodiments described herein, a dielectric barrier discharge (DBD) (also known as a “silent discharge”) technique is used to create microdischarges of atmospheric pressure plasma. In a DBD technique, a sinusoidal voltage, for example, from the AC voltage source 107 is applied to at least one inner electrode 104, within an insulating dielectric barrier plate 102. Dielectric barrier discharge techniques are described more fully in “Dielectric-barrier Discharges: Their History, Discharge Physics, and Industrial Applications”, Plasma Chemistry and Plasma Processing, Vol. 23, No. 1, March 2003, and “Filamentary, Patterned, and Diffuse Barrier Discharges”, IEEE Transactions on Plasma Science, Vol. 30, No. 4, August 2002, both authored by U. Kogelschatz, the entire disclosures of which are incorporated by reference herein.

In short, to obtain substantially uniform atmospheric pressure plasma in air, a dielectric barrier is placed in between a voltage electrode such as the electrodes 104, and the conductive probe 106 to control the discharge, i.e., choke the production of atmospheric pressure plasma. That is, before the discharge can become an arc, the dielectric barrier 102 chokes the production of the discharge. Because this embodiment is operated using an AC voltage source, the discharge oscillates in a sinusoidal cycle. The microdischarges occur near the peak of each sinusoid. One advantage to this embodiment is that controlled non-equilibrium plasmas and resulting species can be generated at atmospheric pressure using a relatively simple and efficient technique.

In an alternative embodiment, with reference to FIG. 1B, for example, but equally applied to all other embodiments of the dielectric plates throughout this application, the plates 102 can be canted or angled off the vertical. This creates a narrowing of the gap 103. For example, in one embodiment, the plates get progressively closer to each other from the top 105 to the bottom 101. Thus, as the probe 106 is introduced into the gap 103 from the top 105 to the bottom 101 of the plates, the area of space between the probe 106 and the adjacent plates is reduced. In this configuration, because the plates are closer to each other and thus the electrodes are closer, plasma can be formed at a lower turn-on voltage. In other words, the canted design allows the device to create plasma at a relatively lower power level. In an embodiment, the degree of offset ranges from about 0 degrees to 10 degrees. In another embodiment, the degree of offset ranges from about 3 degrees to about 6 degrees. Alternatively, the canting can be other than off the vertical. It can vary in any manner that provides the production of plasma at a lower power level.

In an alternative configuration, the ground electrode as described herein may comprise a mesh. The mesh forms a physical dispersal mechanism that prevents excess electrical flow to any point. This assists in preventing arcing or uneven plasma formation.

In operation, in accordance with an embodiment of the present invention, the AC voltage source 108 applies a sinusoidal voltage to the inner electrodes 104. Then, the plurality of conductive probes 106 are introduced into the gap 103 between adjacent elongated dielectric barrier plates 102. A dielectric barrier discharge (DBD) is produced. This DBD forms atmospheric pressure plasma, represented by arrows 112. In an embodiment of the present invention, atmospheric pressure plasma is obtained when, during one phase of the applied AC voltage, charges accumulate between the dielectric surface and the opposing electrode until the electric field is sufficiently high enough to initiate an electrical discharge through the gas gap (also known as “gas breakdown”). During an electrical discharge, an electric field from the redistributed charge densities may oppose the applied electric field and the discharge is terminated. In one embodiment, the applied voltage-discharge termination process may be repeated at a higher voltage portion of the same phase of the applied AC voltage or during the next phase of the applied AC voltage.

To create the necessary DBD for an embodiment of the present invention, the AC voltage source 108 includes an AC power amplifier 109 and a high voltage transformer 111. The frequency ranges from about 10,000 Hertz to 20,000 Hertz, sinusoidal. The power amplifier has an output voltage of from about 0 Volts (rms) to 22.5 Volts (rms) with an output power of 500 watts. The high voltage transformer ranges from about 0 V (rms) to 7,000 Volts (rms) (which is about 10,000 volts (peak)). Depending on the geometry and gas used for the plasma device, the applied voltages can range from about 500 to 10,000 Volts (peak), with frequencies ranging from line frequencies of 50 Hertz up to 20 Megahertz.

In an embodiment of the present invention, the frequency of a power source may range from 50 Hertz up to 20 Megahertz. In another embodiment of the present invention, the voltage and frequency may range from 5,000 to 15,000 Volts (peak) and 50 Hertz to 50,000 Hertz, respectively.

The gas used in the plasma device 200 of the present invention can be ambient air, pure oxygen, any one of the rare gases, or a combination of each such as a mixture of air or oxygen with argon and/or helium. Also, the gas may include an additive, such as hydrogen peroxide, or organic compounds such as methanol, ethanol, ethylene or isopropynol to enhance specific atmospheric pressure plasma cleaning properties.

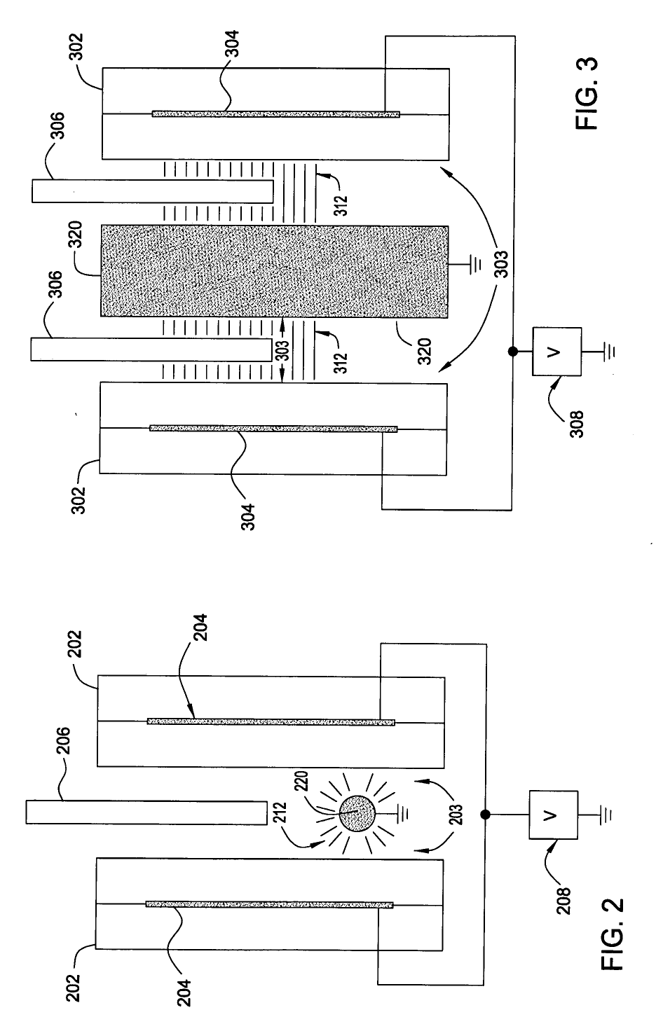

Referring now to FIG. 2, elongated dielectric barrier plates 202 similar to those described with respect to FIGS. 1A and 1B are depicted. Inner electrodes 204 and an AC voltage source 208, similar to those previously described, are also depicted in FIG. 2. In addition, this embodiment includes a ground electrode 220. The ground electrode 220 is positioned within the gap 203 between two elongated dielectric barrier plates 202. The ground electrode 220 is electrically grounded with respect to the AC voltage source 208. The ground electrode 220 can be covered by, or coated with, a non-conductive, dielectric material, which may comprise the same material as that described herein with respect to the dielectric barrier plates.

With the ground electrodes 220 in place, the probe 206 can be non-conductive. For example, the probe 206 can be made of plastic or any other type of material that does not conduct a current and as such would not cause a discharge to occur. In this way, the probe is not needed to create the DBD and therefore does not need to be limited to conductive material. Rather, the DBD 212 is created between the plates 202 and the ground electrode 220 for treating or cleaning at least a portion of the non-conductive probe 206. The ground electrode 220 is shaped as a sphere or an elongated cylinder or rod. However, it can be any shape provided it functions as a ground electrode. For example, it can be an elongated square, rectangle, oval, polygon, triangle or irregular geometric shape.

FIG. 3 depicts elongated dielectric barrier plates 302 similar to those previously described. Inner electrodes 304 and an AC voltage source 308, similar to those previously described, are also depicted in FIG. 3. In addition, this embodiment includes a ground electrode 320. The ground electrode 320 is positioned within the predetermined gap 303 between the two elongated dielectric barrier plates 302. The ground electrode 320 is electrically grounded with respect to the AC voltage source 308. With the ground electrode 320 in place, as discussed previously, the probes 306 can be non-conductive. Given the shape and size of this ground electrode 320, at least two non-conductive probes 206 may be introduced and cleaned through the process described herein. The ground electrode 320 is depicted as an elongated rectangle. However, it is to be understood that the shape can be selected from any one of the following shapes: spherical, square, rectangular, oval, polygonal, triangular and irregularly geometric.

In an alternative embodiment, the ground electrode 320 may be covered with a dielectric material similar to that dielectric material described herein. In this configuration, the covered ground electrode 320 can be connected to ground and the next adjacent dielectric plate 302 with inner electrode 304 are connected to the AC source 308.

The elongated dielectric barrier plates 302 are placed adjacent one another, defining a plane. Alternatively, the plates 302 can be staggered in a non-planar arrangement with respect to one another. The gap 303 is sized to allow at least a portion of each of the plurality of probes 306 to be introduced between the elongated dielectric barrier plates 302. The gap 303 can range from about 0 mm to about 10 mm. The gap 303 may also range from about 2 mm to about 9.5 mm. In one embodiment, the gap 303 is about 9 mm. In another embodiment, the gap is about 4.5 mm. In yet another embodiment, the gap is about 2.25 mm.

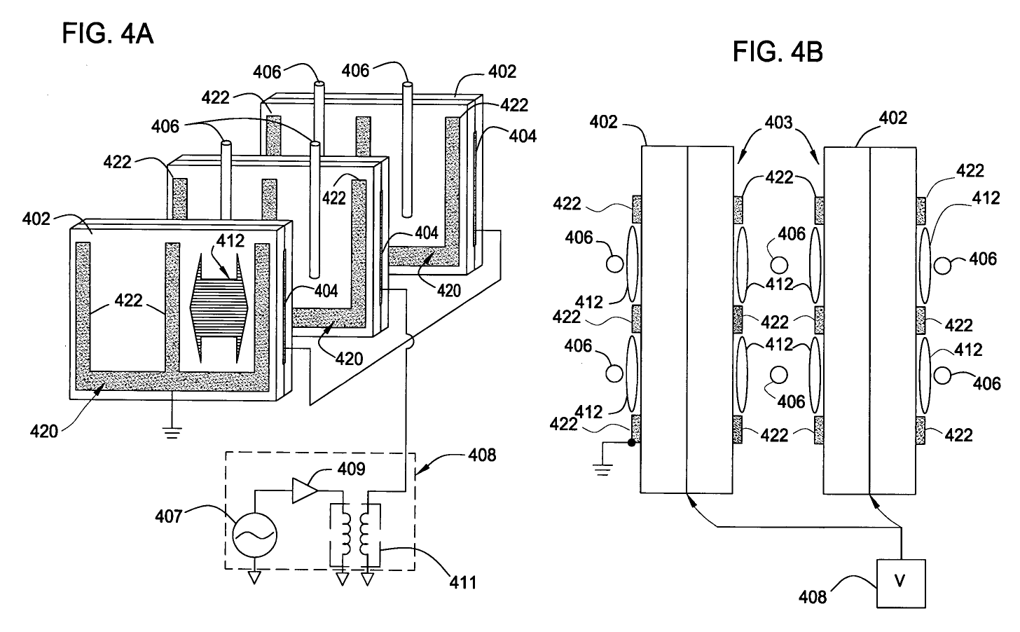

In another embodiment, as shown in FIGS. 4A and 4B, instead of having a ground electrode positioned within the gap 403 as previously described, the ground electrodes 420 are configured and arranged on the outer surfaces of the elongated dielectric barrier plates 402. The ground electrodes 420 include upwardly extending portions 422 spaced apart along the length of the elongated dielectric barrier plates 402. In operation, a dielectric barrier surface discharge is created to form plasma 412 between the upwardly extending portions 422 and the outer surface of the elongated dielectric barrier plates 402. The non-conductive probes 406 are introduced between the spaces of the upwardly extending portions 422 and the plates 402 so that the plasma formed can clean and surface condition at least a portion of the non-conductive probes 406.

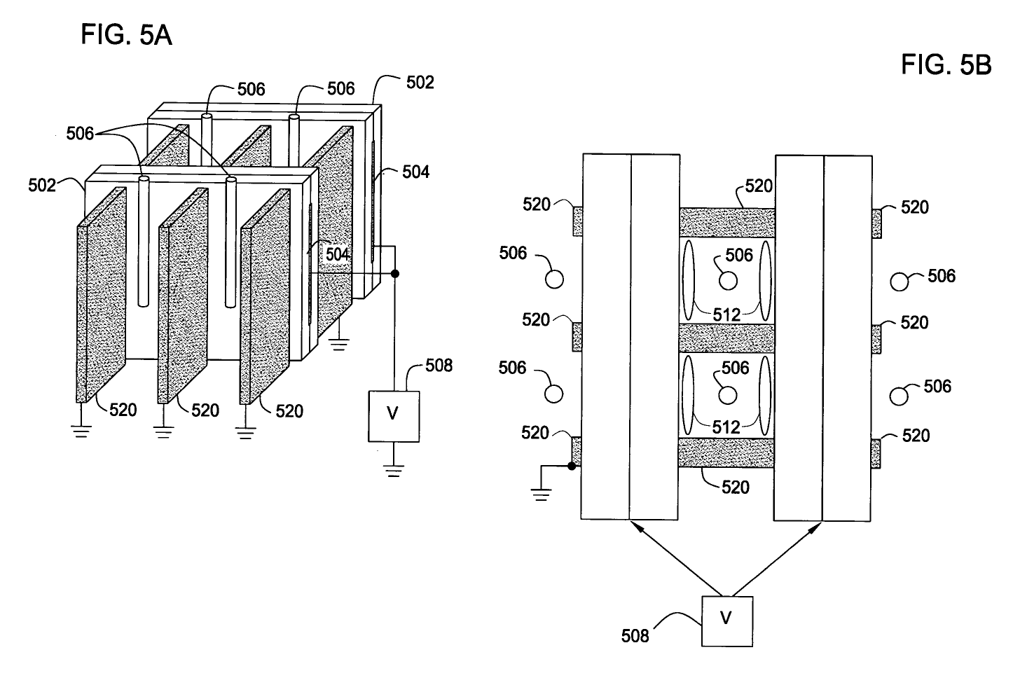

FIGS. 5A and 5B depict another embodiment of the present invention. Here, the ground electrodes 520 are spaced apart along the length of the elongated dielectric barrier plates 502. In this embodiment, the ground electrodes 520 extend outwardly from, and substantially perpendicular to, the outer surfaces of the elongated dielectric barrier plates 502. Similar to the embodiment disclosed with respect to FIGS. 4A and 4B, plasma 512 is formed on the surface of the plates 502 between the ground electrodes 520. As described previously, non-conductive probes are introduced into the spaces between the ground electrodes 520 proximate the plates 502.

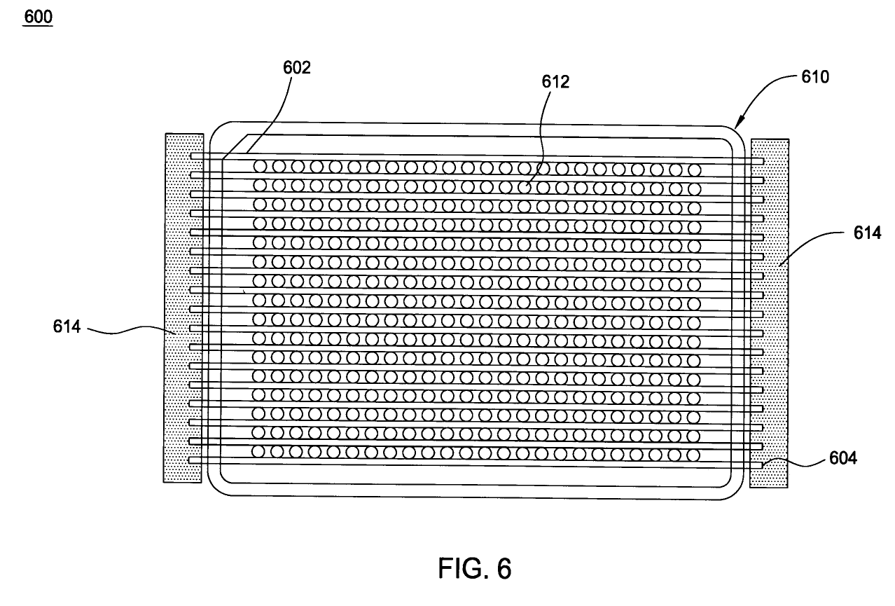

Referring to FIG. 6, a top plan view of the above described plasma devices configured and arranged in a standard microtiter plate format 600. For example, the wells 612 and pitch between rows of wells of the microtiter plate format 600 are sized to accommodate 96 openings for receiving a plurality of fluid handling probes. In another embodiment, the wells 612 and pitch is sized to accommodate 384 openings for receiving a plurality of probes, as depicted in FIG. 6. As another embodiment, the wells 612 and pitch is sized to accommodate 1536 openings for receiving a plurality of probes.

Microtiter plates or microplates, similar to the one depicted in FIG. 6, are small, usually plastic, reaction vessels. The microplate 600 has a tray or cassette 610 covered with wells or dimples 612 arranged in orderly rows. These wells 612 are used to conduct separate chemical reactions during a fluid testing step. The large number of wells, which typically number 96, 384 (as shown in FIG. 6) or 1536, depending upon the well 612 size and pitch between rows of wells of the microplate, allow for many different reactions to take place at the same time. Microplates are ideal for high-throughput screening and research. They allow miniaturization of assays and are suitable for many applications including drug testing, genetic study, and combinatorial chemistry.

The microplate 600 has been equipped with an embodiment of the present invention. Situated in rows on the top surface of the microplate 600 and between the wells 612 are a plurality of elongated dielectric barrier plates 602 similar to those described hereinabove. The inner electrodes 604 of the elongated dielectric barrier plates 602 are electrically coupled to the AC voltage source through contact planes 614 of the cassette 610. The elongated dielectric barrier plates 602 are each spaced apart in this particular embodiment a pitch of about 4.5 mm. In alternative embodiments, where the well count is 96, the plates 602 are spaced apart a pitch of about 9 mm. In yet another embodiment, where the wells 612 numbered 1536, the pitch is 2.25 mm. During a cleaning step, the wells 612 of the microplate 600 do not necessarily function as liquid holding devices. Rather, the wells 612 are used to allow receiving space for the probes when the probes are fully introduced between the elongated dielectric barrier members 602.

This matrix can accommodate ground electrodes as well such that non-conductive probes may be cleaned using the microplate 600 set up.

In operation, the microplate 600 is placed in, for example, a deck mounted wash station. In, for example, an automated microplate liquid handling instrumentation, the system performs an assay test. Then, at least the probe tips of the fluid handling device require cleaning. As such, the fluid handling device enters the wash station. A set of automated commands initiate and control the probes to be introduced to the microplate 600 proximate the elongated dielectric barrier plates 602. At or about the same time, the AC voltage power source is initiated. Alternatively, the power source remains on during an extended period so that the system is ready to create a DBD.

During the power-on phase, as the probes are introduced to the dielectric plates 602 of the microplate 600, dielectric barrier discharges are formed between the plates 602 and the probes. In an embodiment where the probes are hollow, the reactive and energetic components or species of the plasma are repeatedly aspirated into the probes, using the fluid handling devices' aspirating and dispensing capabilities. The aspiration volume, rate and frequency are determined by the desired amount of cleaning/sterilization required.

Any volatized contaminants and other products from the plasma may be vented through the bottom of the microplate 600 by coupling the bottom of the tray 610 to a region of negative pressure such as with a modest vacuum. This vacuum may be in communication with the wells 612 and is capable of drawing down byproducts through to the bottom of the device and into an exhaust manifold (not shown) of the cleaning station test set up.

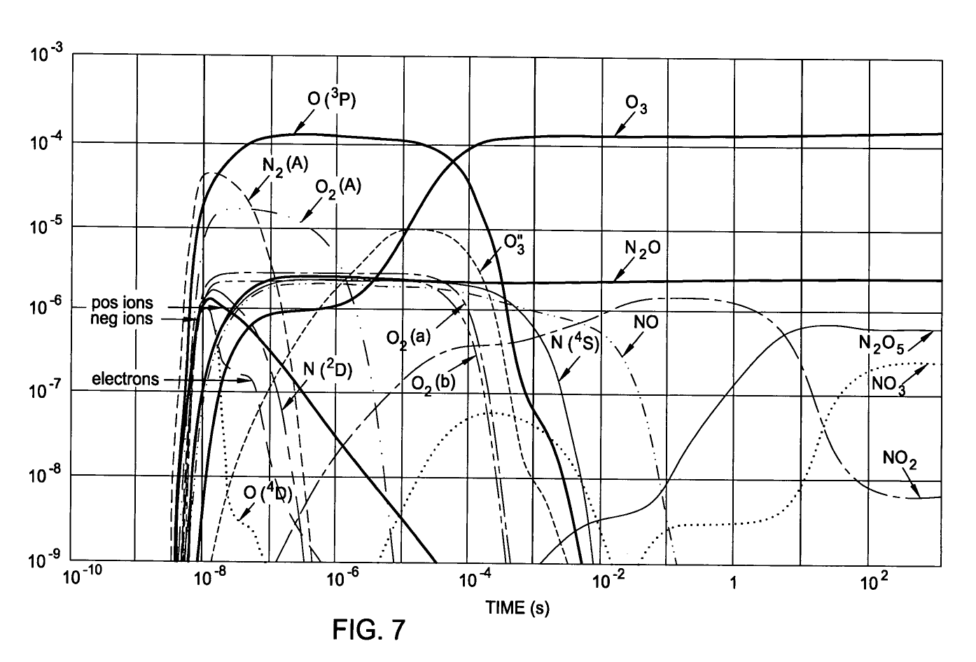

In an embodiment, ions, excited and metastables species (corresponding emitted photons), and free radicals are found in the atmospheric pressure plasma and remain long enough to remove substantially all of the impurities and contaminates left from the previous test performed by the fluid handling device's probes. These particle species remain longer (see FIG. 7) than the initial plasma formed from a DBD or microdischarge and are therefore effective in cleaning the probes in preparation for the next test as the initially formed plasma itself.

In particular, FIG. 7 represents a graph of the relative concentrations of different particle species in time after the initiation of a single microdischarge forming atmospheric pressure plasma in air. Metastables are represented by N₂(A) and N₂(B). Free radicals are represented by O₃, O(³P), N(⁴S) and NO. Free radicals and metastables are represented by O(¹D) and N(²D). In non-equilibrium microdischarges, the fast electrons created by the discharge mechanism mainly initiate the chemical reactions in the atmospheric pressure plasma. The fast electrons can inelastically collide with gas molecules and ionize, dissociate and/or excite them to higher energy levels, thereby losing part of their energy, which is replenished by the electric field. The resulting ionic, free radical, and excited species can then, due to their high internal energies or reactivities, either dissociate or initiate other reactions.

In plasma chemistry, the transfer of energy via electrons to the species that take part in the reactions must be efficient. This can be accomplished by a short discharge pulse. This is what occurs in a microdischarge. FIG. 7 shows the evolution of the different particle species initiated by a single microdischarge in “air” (80% N₂, plus 20% O₂). The short current pulse of roughly 10 ns duration deposits energy in various excited levels of N₂ and O₂, some of which lead to dissociation and finally to the formation of ozone and different nitrogen oxides. After about 50 ns, most charge carriers have disappeared and the chemical reactions proceed without major interference from charge carriers and additional gas heating.

While the foregoing is directed to embodiments of the present invention, other and further embodiments of the invention may be devised without departing from the basic scope thereof, and the scope thereof is determined by the claims that follow.

What is claimed is:

1. An apparatus for cleaning objects using plasma, comprising:
a plurality of elongated dielectric barrier plates, arranged adjacent each other and spaced apart to define predetermined gaps therebetween; and
a plurality of inner electrodes, each contained within, and extending substantially along the length of, respective ones of the elongated dielectric barrier plates.

2. The apparatus of claim 1, wherein each plate comprises a top and a bottom having a height “h” defined therebetween, and each inner electrode is positioned substantially equidistant between the top and bottom and extends between the top and bottom less than the height “h”.

3. The apparatus of claim 1, wherein the objects comprise a plurality of conductive probes, the probes arranged and configured to be introduced proximate the elongated dielectric barrier plates.

4. The apparatus of claim 3, further comprising a voltage source electrically coupled to the inner electrodes for producing a dielectric barrier discharge between the conductive probes and the elongated dielectric barrier plates, whereby plasma is formed to clean at least a portion of the probes.

5. The apparatus of claim 3, wherein the elongated dielectric barrier members are arranged to define a plane.

6. The apparatus of claim 5, wherein the elongated dielectric barrier members are spaced apart from each other at substantially regular intervals to define substantially regular predetermined gaps therebetween.

7. The apparatus of claim 6, wherein each predetermined gap is sized to allow at least a portion of the conductive probes to be introduced between the elongated dielectric barrier plates.

8. The apparatus of claim 7, wherein each predetermined gap is sized from about 0 mm to about 10 mm.

9. The apparatus of claim 1, wherein each elongated dielectric barrier plate is arranged in parallel to the next adjacent elongated plate.

10. The apparatus of claim 1, further comprising a plurality of ground electrodes, each arranged within each of the predetermined gaps.

11. The apparatus of claim 10, wherein the objects comprise a plurality of non-conductive probes, the probes arranged and configured to be introduced proximate the elongated dielectric barrier plates and ground electrodes.

12. The apparatus of claim 11, further comprising a voltage source electrically coupled to the inner electrodes for producing a dielectric barrier discharge between the ground electrodes and the elongated dielectric barrier plates, whereby plasma is formed to clean at least a portion of the non-conductive probes.

13. The apparatus of claim 10, wherein the shape of the ground electrodes is selected from a group consisting of spherical, square, rectangular, oval, polygonal, triangular and irregularly geometric.

14. The apparatus of claim 1, further comprising a plurality of ground electrodes positioned on the outer surfaces, and spaced apart along the length, of the elongated dielectric barrier plates.

15. The apparatus of claim 14, wherein each electrode comprises upwardly extending portions.

16. The apparatus of claim 15, wherein the objects comprise a plurality of non-conductive probes, the probes arranged and configured to be introduced proximate the elongated dielectric barrier plates and between the upwardly extending portions of the ground electrodes.

17. The apparatus of claim 16, further comprising a voltage source electrically coupled to the inner electrodes for producing a dielectric barrier discharge between the upwardly extending portions of the ground electrodes along the outer surfaces of the elongated dielectric barrier plates, whereby plasma is formed to clean at least a portion of the non-conductive probes.

18. The apparatus of claim 14, wherein the plurality of ground electrodes are discrete ground electrode extending outwardly and substantially perpendicular to the outer surface of the elongated dielectric barrier plates.

19. The apparatus of claim 1, wherein the elongated dielectric barrier plates are arranged in a microtiter plate matrix format.

20. The apparatus of claim 1, wherein the elongated dielectric barrier plates are arranged in a non-planar configuration.

21. A method for cleaning a plurality of non-conductive objects, comprising:
providing a plurality of elongated dielectric barrier plates, each having inner electrodes arranged therein, the plates spaced apart to define a predetermined gap therebetween;
providing a plurality of ground electrodes adjacent the elongated dielectric barrier plates;
introducing non-conductive objects proximate the elongated dielectric barrier plates and the ground electrodes; and
generating a dielectric barrier discharge to form plasma between the elongated dielectric barrier plates and respective ground electrodes for cleaning at least a portion of each of the non-conductive objects.

22. The method of claim 21, wherein the plasma comprises energetic and reactive particles selected from a group consisting of electrons, ions, excited and metastable species, and free radicals.

23. The method of claim 21, wherein the plasma comprises energetic and reactive particles selected from a group consisting of: excited and metastable species of N₂, N, O₂, O; free radicals such as OH, NO, O, and O₃; and ultraviolet photons ranging in wavelengths from 200 to 400 nanometers resulting from N₂, NO, and OH emissions.
